(19) United States
(12) Patent Application Publication
(10) Pub. No.: US 2019/0098973 A1
(43) Pub. Date: Apr. 4, 2019

(54) MEDICATION ORGANIZER

(71) Applicants: Wanda Proctor, Euless, TX (US); Thomas Proctor, Euless, TX (US); R. Charles Stuart, Norman, OK (US)

(72) Inventors: Wanda Proctor, Euless, TX (US); Thomas Proctor, Euless, TX (US); R. Charles Stuart, Norman, OK (US)

(21) Appl. No.: 16/151,075

(22) Filed: Oct. 3, 2018

Related U.S. Application Data
(60) Provisional application No. 62/567,489, filed on Oct. 3, 2017.

(51) Int. Cl. A45C 11/26; A61J 1/16

(52) U.S. Cl. CPC A45C 11/26; A45C 13/02; A61J 1/16

(57) ABSTRACT

A medication organizer including an organizer-body, a plurality of attachment-straps and at least one pocket. The plurality of attachment-straps are configured to hold and store medication containers. In one embodiment, the at least one pocket is configured to store liquid medication containers. The medication organizer is useful for organizing and storing medication and may be particularly useful for airport security.

### CROSS REFERENCE TO RELATED APPLICATION

The present application is related to and claims priority to U.S. Provisional Patent Application No. 62/567,489 filed Oct. 3, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of organizers and more specifically relates to an organizer for medications.

### 2. Description of Related Art

Many individuals, especially elderly individuals, have prescribed pharmaceuticals that they must take on prescribed schedule. A conventional carrier may have for example seven individual small compartments labeled Sunday through Saturday. Depending on the number and types of medications the individual person may have two or more of these standard carriers.

Federal air travel regulations require prescription medication be transported in its original container if carried onto a plane, making it difficult for people with multiple medications to travel. As a result, many people may condense their medication and pack it in a checked suitcase. Unfortunately, it can be difficult for people to tell one pill from another, potentially mixing up their medication or taking the wrong dose—both of which can be extremely dangerous. Thus, a suitable solution is desired.

U.S. Pat. No. 7,111,733 to Majorie Foote relates to a medicine vial organizer and carrier. The described medicine vial organizer and carrier includes a prescription pill container organizer and carrier includes one or more rows of elastic loop holders attached to the inside of a piece of flexible material in which are held prescription pill containers, the piece folded or rolled up to enclose the prescription pill containers. Pockets for documents and a tethered magnifier for reading the prescription pill containers labels are also installed next to the rows of holders.

### BRIEF SUMMARY OF THE INVENTION

In view of the foregoing disadvantages inherent in the known organizers art, the present disclosure provides a novel medication organizer. The general purpose of the present disclosure, which will be described subsequently in greater detail, is to provide an efficient and effective means for organizing a plurality of medications.

A medication organizer is disclosed herein. The medication organizer includes an organizer-body which may include an inner-surface and an outer-surface opposite the inner-surface. The organizer-body may be made from a flexible sheet of material and the flexible sheet of material may be configured to be selectively rolled into a compact-state and selectively unrolled into an extended-state. A plurality of attachment-straps may be each individually secured to the inner-surface of the organizer-body and each of the plurality of attachment-straps may be configured to receive and hold at least one medication container. At least one pocket may be secured to the inner-surface of the organizer-body. The at least one pocket may define a storage-capacity and the storage-capacity may be configured to receive and hold at least one item.

A method of using medication organizer is also disclosed herein. The method of using medication organizer may comprise the steps of: providing the medication organizer as above; securing at least one medication container within one of the plurality of attachment-straps; placing at least one item within the at least one pocket; and rolling the organizer-body into the compact-state.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a medication organizer, constructed and operative according to the teachings of the present disclosure.

FIG. 1 is a front perspective view of the medication organizer during an ‘in-use’ condition, according to an embodiment of the disclosure.

FIG. 2A is a side-front perspective view of the medication organizer of FIG. 1, according to an embodiment of the present disclosure.

FIG. 2B is a side-front perspective view of the medication organizer of FIG. 1, according to an embodiment of the present disclosure.

FIG. 3A is a side-front perspective view of the medication organizer of FIG. 1, according to an embodiment of the present disclosure.

FIG. 3B is a side-front perspective view of the medication organizer of FIG. 1, according to an embodiment of the present disclosure.

FIG. 4 is a side-front perspective view of the medication organizer of FIG. 1, according to an embodiment of the present disclosure.

FIG. 5 is a flow diagram illustrating a method of use for the medication organizer, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to organizers and more particularly to a medication organizer as used to improve organization means for medication.

Generally, disclosed is a prescription medication organizer that holds approximately 16 medicine bottles and rolls up into a sleeve, perfect for traveling on an airplane. The organizer may comprise a roll-up case, made from canvas or other suitable fabric, used to organize prescription medication bottles. The case may have five panels; the bottom four panels can each have four compartments and made from hook-and-loop material. Each compartment may have hook-and-loop fasteners and elastic bands to house a medication container in a secure manner, no matter its size. A top panel may include a clear zippered pouch for over-the-counter medication or makeup. Across a top of the case may be a hook-and-loop strap that holds the organizer together when rolled up. On an exterior of the organizer may be a hanger or cloth handle. The organizer may measure approximately 14″ in length and 8″ in width. The exact specifications may vary upon manufacturing.

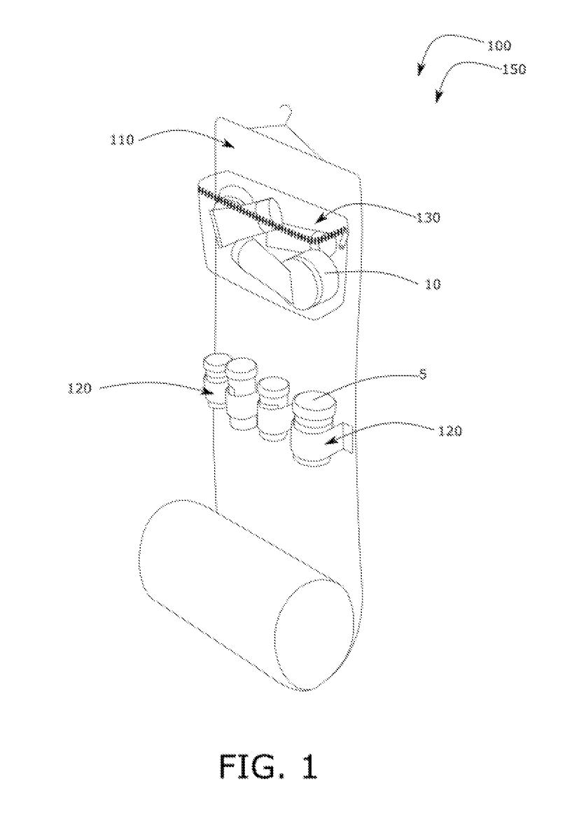

Referring now more specifically to the drawings by numerals of reference, there is shown in FIGS. 1-4, various views of a medication organizer 100.

FIG. 1 shows a medication organizer 100 during an ‘in-use’ condition 150, according to an embodiment of the present disclosure. As Illustrated, the medication organizer 100 may include an organizer-body 110, a plurality of attachment-straps 120 and at least one pocket 130. The medication organizer 100 may be used to hold at least one item 10 or at least one medication-container 5. As shown here, the at least one medication-container 5 may be a plurality of medication containers and the at least one item 10 may be a liquid-medication container. Other items contemplated for storage may be cosmetics including makeup, hair styling products, skincare, etc. It should be appreciated that the medication organizer 100 may be used to store many different items.

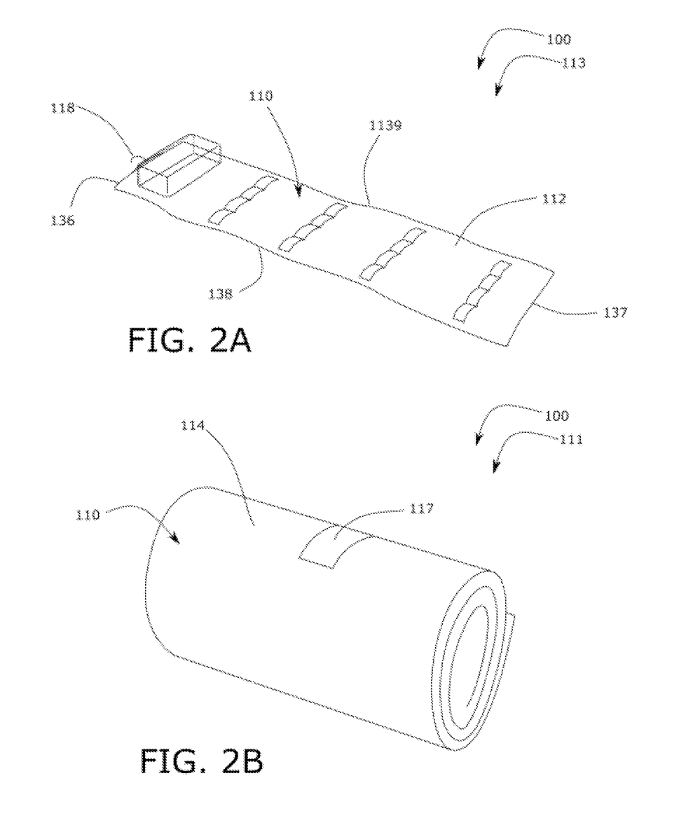

FIG. 2A-2B show side-front perspective views of the medication organizer 100 of FIG. 1, according to an embodiment of the present disclosure. Shown in these figures are the organizer-body 110 in a compact-state 111 and an extended-state 113. The organizer-body 110 may include an inner-surface 112 and an outer-surface 114 opposite the inner-surface 112. Further, the organizer-body 110 may be made from a flexible sheet of material configured to be selectively rolled into a compact-state 111 and selectively unrolled into an extended-state 113. As shown, the outer-surface 114 of the organizer-body 110 may include a second fastening-means 117 configured to secure the organizer-body 110 in the compact-state 111. In a preferred embodiment, the second fastening-means 117 may be a hook and loop fastener. However, other fastening-means are contemplated. For example, buttons, snap fasteners, hook and eye fasteners, and the like.

The organizer-body 110 may further include a top-side 136, a bottom-side 137 opposite the top-side 136, a left-side 138 and a right-side 139 opposite the left-side 138. In this embodiment, the top-side 136 of the organizer-body 110 may include a hanger 118 for attaching the organizer to a surface. The hanger 118 may be made from a sturdy material to support a weight of the organizer-body 110 when filled with the plurality of medication containers and/or the liquid-medication. For example, the hanger 118 may be a metal material such as stainless steel, aluminum, etc., a wood material or a plastic material. In another embodiment, the hanger 118 may be a fabric/cloth material.

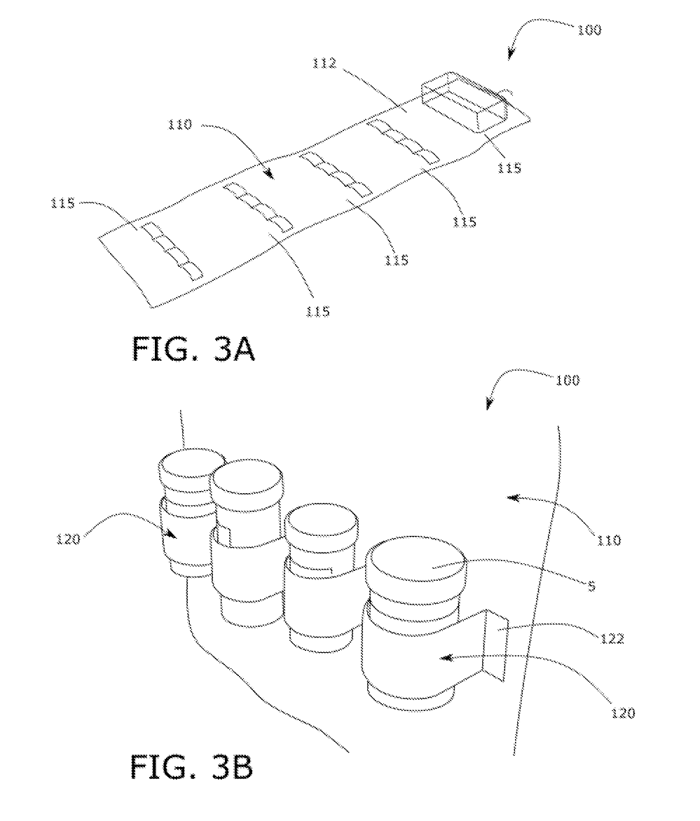

FIG. 3A-3B show side-front perspective views of the medication organizer 100 of FIG. 1, according to an embodiment of the present disclosure. Shown here is the plurality of attachment-straps 120 within the organizer-body 110. The organizer-body 110 may be divided into five panels 115. As shown here, the five panels 115 may be viewable on the inner-surface 112 of the organizer-body 110. The plurality of attachment-straps 120 may each be individually secured to the inner-surface 112 of the organizer-body 110 and configured to receive and hold at least one medication-container 5. In one embodiment, at least four of the five panels 115 may include the plurality of attachment-straps 120. Further, each of the four of the panels may include four said attachment-straps 120. It should be appreciated however that the organizer-body 110 is not limited to five panels, and that different panel configurations are contemplated.

Each of the plurality of attachment-straps 120 may comprise an elastic-material configured to receive and hold medication containers of different sizes. In use, a user may stretch one the plurality of attachment-straps 120, place the medication container within the attachment-strap, and release the attachment-strap to allow the attachment-strap to tightly hold the medication container.

Further, each of the plurality of attachment-straps 120 may include a first fastening-means 122 configured to secure the plurality of attachment-straps 120 to the inner-surface 112. In this embodiment, the user may unfasten the attachment-strap via the first fastening-means 122, place the medication container within the attachment-strap and fasten the attachment-strap to the inner-surface 112 of the organizer-body 110 via the first fastening-means 122. The first fastening-means 122 may be the hook and loop fastener. However, as above, other fastening-means are contemplated. Further, the plurality of attachment-straps 120 may include different sizes configured to accommodate differently sized medication containers.

In one embodiment, each of the plurality of attachment-straps 120 may include removable (functional) indicia thereon. For example, the indicia may detail what the medication is inside of the particular attachment-strap. In other embodiments, the at least one medication-container 5 may include the indicia and the attachment-strap may be situated in such a way that allows the indicia to be easily seen. This may be particularly useful when going through airport security as the user may not have to remove all of the at least one medication-containers 5 from the medication organizer 100.

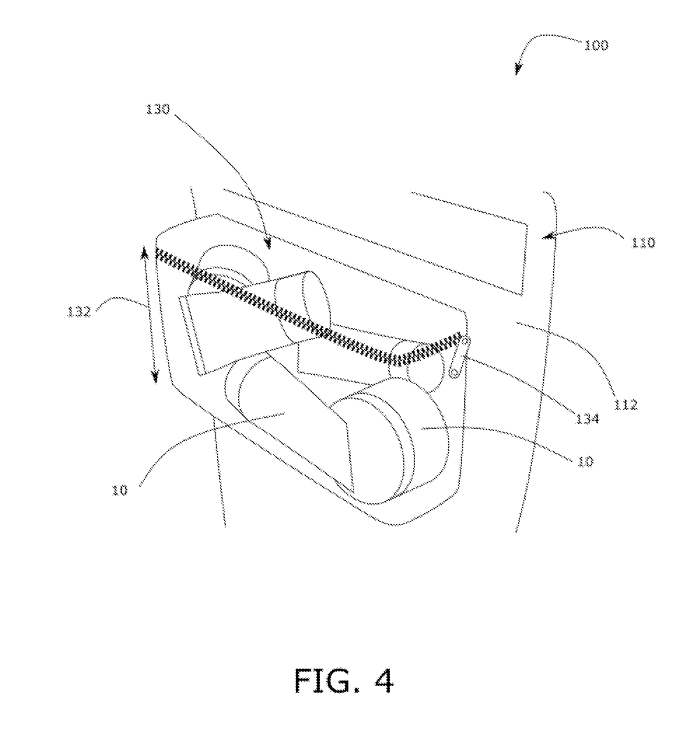

FIG. 4 shows a front perspective view of the medication organizer 100 of FIG. 1, according to an embodiment of the present disclosure. Shown here is the at least one pocket 130 within the organizer-body 110. As shown, the at least one pocket 130 may be secured to the inner-surface 112 of the organizer-body 110. The at least one pocket 130 may define a storage-capacity 132 and the storage-capacity 132 may be configured to receive and hold at least one item 10. As above, the organizer-body 110 may be divided into five panels 115 (FIG. 3A). In this embodiment, at least one of the five panels 115 (FIG. 3A) include the at least one pocket 130. In the preferred embodiment, the at least one pocket 130 may include a third fastening-means 134 configured to secure the at least one item 10 therein. In one example, the third fastening-means 134 may be a zipping-fastener. Other fastening means are contemplated however, such as hook and loop, hook and eye, snap fasteners, buttons, etc.

Further, in the preferred embodiment, the at least one pocket 130 may be transparent. The transparency may be particularly useful for when taking the medication organizer 100 through airport security, as above, as the user may not have to remove all of their things from the at least one pocket 130. In one example, the at least one pocket 130 may be made from a plastic material. However, other materials may be used.

As shown here and discussed above, the at least one item 10 may comprise a liquid at least one medication-container 5. In this example, the storage-capacity 132 may be sized to receive the liquid at least one medication-container 5. In another embodiment, the at least one item 10 may a cosmetic-item and the storage-capacity 132 may be sized to receive the cosmetic-item.

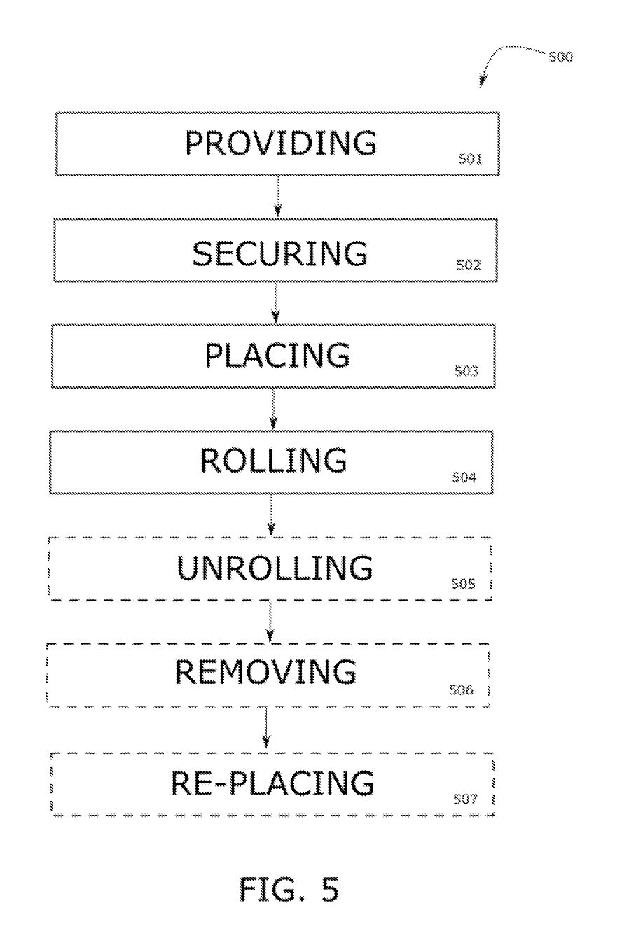

FIG. 5 is a flow diagram illustrating a method of using a medication organizer 500, according to an embodiment of the present disclosure. As illustrated, the method of using a medication organizer 500 may include the steps of: providing the medication organizer 100 as above; step two 502, securing at least one medication-container 5 within one of the plurality of attachment-straps 120; step three 503, placing at least one item 10 within the at least one pocket 130; and step four 504, rolling the organizer-body 110 into the compact-state 111. Further steps may include: step five 505, unrolling the organizer-body 110 into the extended-state 113; step six 506, removing at least one of the medication container and the at least one item 10 from the one of the plurality of attachment-straps 120 and the at least one pocket 130, respectively; and step seven 507, re-placing the one of the at least one medication-container 5 and the at least one item 10 into the one of the plurality of attachment-straps 120 and the at least one pocket 130, respectively.

It should be noted that step five 505, step six 506, and step seven 507 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for medication organizer 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A medication organizer comprising:
an organizer-body including an inner-surface and an outer-surface opposite the inner-surface, the organizer-body being made from a flexible sheet of material, and wherein the flexible sheet of material is configured to be selectively rolled into a compact-state and selectively unrolled into an extended-state;
a plurality of attachment-straps each individually secured to the inner-surface of the organizer-body, and wherein each of the plurality of attachment-straps are configured to receive and hold at least one medication container; and
at least one pocket secured to the inner-surface of the organizer-body, the at least one pocket defining a storage-capacity, and wherein the storage-capacity is configured to receive and hold at least one item.

2. The medication organizer of claim 1, wherein each of the plurality of attachment-straps comprise an elastic-material configured to receive and hold medication containers of different sizes.

3. The medication organizer of claim 2, wherein the organizer-body is divided into five panels.

4. The medication organizer of claim 3, wherein at least four of the five panels include the plurality of attachment-straps.

5. The medication organizer of claim 4, wherein each of the four of the panels include four said attachment-straps.

6. The medication organizer of claim 5, wherein at least one of the five panels include the at least one pocket.

7. The medication organizer of claim 1, wherein each of the plurality of attachment-straps include a first fastening-means configured to secure the plurality of attachment-straps to the inner-surface.

8. The medication organizer of claim 7, wherein the first fastening-means is hook and loop fastener.

9. The medication organizer of claim 1, wherein the at least one item comprises a liquid medication-container and the storage-capacity is sized to receive the liquid medication-container.

10. The medication organizer of claim 1, wherein the at least one item comprises a cosmetic-item and the storage-capacity is sized to receive the cosmetic-item.

11. The medication organizer of claim 1, wherein the at least one pocket includes a third fastening-means configured to secure the at least one item therein.

12. The medication organizer of claim 11, wherein the third fastening means is a zipping-fastener.

13. The medication organizer of claim 12, wherein the at least one pocket is transparent.

14. The medication organizer of claim 1, wherein the outer-surface of the organizer-body includes a second fastening-means configured to secure the organizer-body in the compact-state.

15. The medication organizer of claim 14, wherein the second fastening-means is the hook and loop fastener.

16. The medication organizer of claim 15, wherein the organizer-body further includes a top-side, a bottom-side opposite the top-side, a left-side and a right-side opposite the left-side.

17. The medication organizer of claim 16, wherein the top-side of the organizer-body includes a hanger for attaching the organizer to a surface.

18. A medication organizer comprising:
an organizer-body including an inner-surface and an outer-surface opposite the inner-surface, the organizer-body being made from a flexible sheet of material, and wherein the flexible sheet of material is configured to be selectively rolled into a compact-state and selectively unrolled into an extended-state;
a plurality of attachment-straps each individually secured to the inner-surface of the organizer-body, and wherein each of the plurality of attachment-straps are configured to receive and hold at least one medication container; and
at least one pocket secured to the inner-surface of the organizer-body, the at least one pocket defining a storage-capacity, and wherein the storage-capacity is configured to receive and hold at least one item; and
wherein each of the plurality of attachment-straps comprise an elastic-material so as not to set off a metal detection device and configured to receive and hold medication containers of different sizes;
wherein the organizer-body is divided into five panels;
wherein at least four of the five panels include the plurality of attachment-straps;
wherein each of the four of the panels include four said attachment-straps;
wherein at least one of the five panels include the at least one pocket;
wherein each of the plurality of attachment-straps include a first fastening-means configured to secure the plurality of attachment-straps to the inner-surface;
wherein the first fastening-means is hook and loop fastener;
wherein the at least one item comprises a liquid medication-container and the storage-capacity is sized to receive the liquid medication-container;
wherein the at least one item comprises a cosmetic-item and the storage-capacity is sized to receive the cosmetic-item;
wherein the at least one pocket includes a third fastening-means configured to secure the at least one item therein;
wherein the third fastening means is a zipping-fastener;
wherein the at least one pocket is transparent;
wherein the outer-surface of the organizer-body includes a second fastening-means configured to secure the organizer-body in the compact-state;
wherein the second fastening-means is the hook and loop fastener;
wherein the organizer-body further includes a top-side, a bottom-side opposite the top-side, a left-side and a right-side opposite the left-side; and
wherein the top-side of the organizer-body includes a hanger for attaching the organizer to a surface.

19. A method of using a medication organizer, the method comprising the steps of:
providing the medication organizer, the medication organizer including:
an organizer-body including an inner-surface and an outer-surface opposite the inner-surface, the organizer-body being made from a flexible sheet of material, and wherein the flexible sheet of material is configured to be selectively rolled into a compact-state and selectively unrolled into an extended-state, as desired;
a plurality of attachment-straps each individually secured to the inner-surface of the organizer-body, and wherein each of the plurality of attachment-straps are configured to receive and hold at least one medication container; and
at least one pocket secured to the inner-surface of the organizer-body, the at least one pocket defining a storage-capacity, and wherein the storage-capacity is configured to receive and hold at least one item;
securing at least one medication container within one of the plurality of attachment-straps;
placing at least one item within the at least one pocket; and
rolling the organizer-body into the compact-state.

20. The method of claim 19, further comprising the steps of:
unrolling the organizer-body into the extended-state;
removing at least one of the medication container and the at least one item from the one of the plurality of attachment-straps and the at least one pocket, respectively; and
re-placing the one of the at least one medication container and the at least one item into the one of the plurality of attachment-straps and the at least one pocket, respectively.
